(19) United States
(12) Patent Application Publication
(10) Pub. No.: US 2013/0057582 A1
(43) Pub. Date: Mar. 7, 2013

(54) DISPLAY CONTROL APPARATUS, METHOD FOR CONTROLLING DISPLAY CONTROL APPARATUS, AND STORAGE MEDIUM

(71) Applicant: Hitoshi Aoki, Yokohama-shi (JP)

(72) Inventor: Hitoshi Aoki, Yokohama-shi (JP)

(73) Assignee: CANON KABUSHIKI KAISHA, Tokyo (JP)

(21) Appl. No.: 13/600,785

(22) Filed: Aug. 31, 2012

(30) Foreign Application Priority Data
Sep. 5, 2011 (JP) 2011-192850

(51) Int. Cl. G09G 5/00

(52) U.S. Cl. 345/633

(57) ABSTRACT

A display control apparatus capable of displaying information about an object detected from a captured image causes a display unit to display information corresponding to even an object that cannot be detected from the captured image, if the information is relevant to a query input by a user.

### BACKGROUND

1. Field of the Disclosure

The disclosure relates to a display control apparatus which causes information about an object in a captured image to be displayed.

2. Description of the Related Art

There has recently been an augmented reality (AR) technology which synthesizes a captured image captured by a camera and attribute information about an object in the captured image for display. For example, a captured image and attribute information about an object in the captured image are synthesized and displayed based on position information using the Global Positioning System (GPS).

U.S. Pat. No. 7,275,043 B2 discusses a technology that includes identifying an object person in a captured image based on feature information for identification use, acquired from a mobile phone that the object person has, acquiring attribute information about the identified person from a server, and displaying the information near the identified object in the captured image.

Japanese Patent Application Laid-Open No. 2010-118019 discusses a technology for acquiring information about an object that is considered to be in an imaging range based on imaging position and direction, and displaying the information in a captured image.

As described above, the conventional AR technologies display attribute information about an object in a captured image. However, there is a problem that even if there is an adjacent object that has information desired by a user as its attribute information, the user-desired information will not be displayed unless the object is framed in the imaging image and identified. Besides, if a captured image is synthesized with attribute information about an object that is not framed in the imaging range, the correspondence between the information and the object cannot be seen. Randomly displaying information in a limited display area of a terminal apparatus that has no rich user interface only provides poor usability to the user.

### SUMMARY

The claimed invention is directed to displaying user-desired information among information associated with an identifier of another apparatus.

According to an aspect of the claimed invention, a display control apparatus includes an identifier acquisition unit configured to acquire an identifier of another apparatus associated with an object, an information acquisition unit configured to acquire information associated with the acquired identifier, a detection unit configured to detect an object corresponding to the acquired identifier from a captured image, a first display control unit configured to cause a display unit to display information corresponding to the identifier corresponding to the object detected by the detection unit, and a second display control unit configured to cause the display unit to display information relevant to a query input by a user, included in the information corresponding to the identifier corresponding to an object not detected by the detection unit.

Further features and aspects of the claimed invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the claimed invention and, together with the description, serve to explain the principles of the claimed invention.

FIG. 1 is a diagram illustrating a configuration of a system according to an exemplary embodiment of the claimed invention.

FIG. 2 is a chart illustrating a conceptual diagram of a database according to a first exemplary embodiment of the claimed invention.

FIG. 3 is a diagram illustrating a configuration of a digital camera.

FIG. 4 is a diagram illustrating a configuration of a mobile phone.

FIG. 5 is a sequence diagram illustrating a system sequence for image capturing processing.

FIG. 6 is a flowchart illustrating processing of the digital camera.

FIG. 7 is a diagram illustrating an example of a display screen where a captured image is displayed.

FIG. 8 is a diagram illustrating an example of the display screen where attribute information is displayed in association with an object.

FIG. 9 is a diagram illustrating another example of the display screen where attribute information is displayed in association with objects.

FIG. 10 is a diagram illustrating an example of the display screen where a query is displayed.

FIG. 11 is a diagram illustrating an example of the display screen where attribute information corresponding to an object that is not included in the captured image is displayed.

FIG. 12 is a sequence diagram illustrating position information registration processing according to a second exemplary embodiment of the claimed invention.

FIG. 13 is a chart illustrating a conceptual diagram of a database according to the second exemplary embodiment.

FIG. 14 is a sequence diagram illustrating a system sequence for image capturing processing according to the second exemplary embodiment.

FIG. 15 is a diagram illustrating an example of the display screen where attribute information corresponding to a query is displayed.

### DESCRIPTION OF THE EMBODIMENTS

Various exemplary embodiments, features, and aspects of the claimed invention will be described in detail below with reference to the drawings.

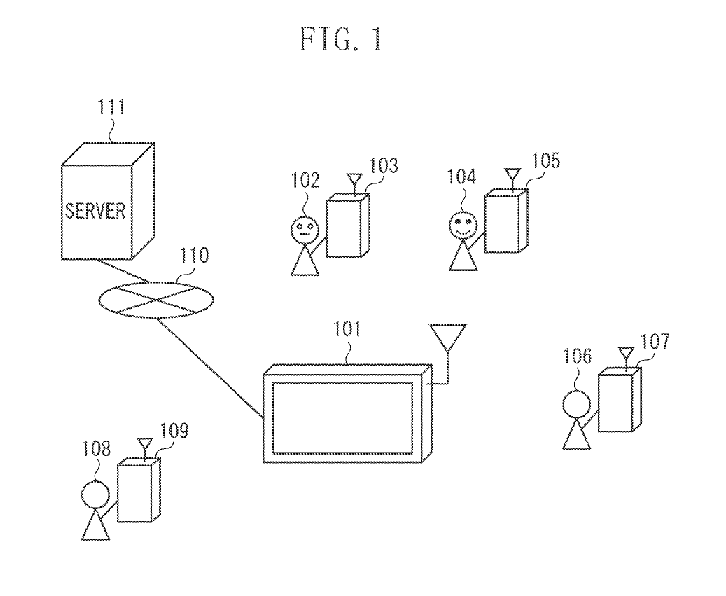

FIG. 1 is a diagram illustrating a system configuration according to a present exemplary embodiment.

A digital camera 101 is a display control apparatus that acquires attribute information from a server 111, synthesizes the acquired attribute information with a captured image, and displays the resultant on a display unit. The attribute information is associated with identification information that is received from another terminal apparatus and allows unique identification of the terminal apparatus.

The digital camera 101 also associates and synthesizes attribute information about an object in the captured image with the object in the captured image, and displays the resultant on the display unit. For example, the digital camera 101 displays information about an owner of a terminal apparatus as superimposed on its display screen. Consequently, a user can easily acquire information about the object in the captured image.

Since the digital camera 101 displays information in association with the object in the captured image, it can be easily identified which object is offering what information. Even if a piece of attribute information pertains to an object that is not included in the captured image, the digital camera 101 synthesizes the captured image and the attribute information, and displays the resultant on the display unit if the attribute information is user-desired information.

Mobile phones 103, 105, 107, and 109 are terminal apparatuses that transmit an identifier capable of unique terminal identification as identification information on a regular basis or in response to a request from another terminal. The identification information may be information for uniquely identifying the users of the terminal apparatuses.

When the server 111 receives an inquiry including identification information about a terminal apparatus from the digital camera 101 through a network 110, the server 111 transmits attribution information associated with the received identification information, retained in its database, to the digital camera 101.

The server 111 also acquires feature information from the database and transmits the feature information to the digital camera 101. The feature information is intended to detect and identify an object associated with the received identification information from the captured image.

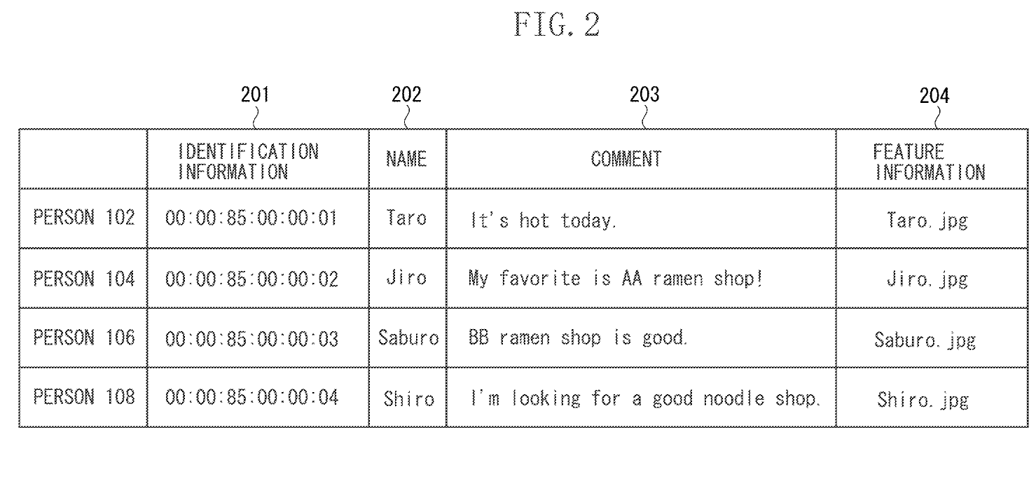

FIG. 2 illustrates an example of information retained in the database that is managed by the server 111.

The database stores table data that associates identification information 201, a name 202 of the owner of a terminal apparatus, a comment 203, and feature information 204 about the terminal apparatus with one another. The identification information 201 includes identifiers for uniquely identifying the terminal apparatus.

FIG. 2 illustrates table data on the mobile phones 103, 105, 107, and 109 which are owned by persons 102, 104, 106, and 108 illustrated in FIG. 1, respectively.

For example, as an identifier that allows unique identification of a terminal apparatus, the identification information 201 includes a media access control (MAC) address or a user identifier (ID) of the owner of the terminal apparatus. The name 202 and the comment 203 are examples of attribute information associated with the identification information 201. Such attribute information is displayed as superimposed on an image captured by the digital camera 101. The attribute information is not limited to names and comments. Universal resource locators (URLs) and other links to external sites may be used. A plurality of items such as hobbies and the date of birth may be included.

The feature information 204 is intended to detect and identify an object associated with identification information 201 from a captured image. In the present exemplary embodiment, a reference image for performing object identification processing by image processing is used as feature information 204. The feature information 204 is not limited to image data. Arbitrary feature data may be used for the object identification processing.

In the present exemplary embodiment, face images of the persons 102, 104, 106, and 108 are stored in the database as feature information 204.

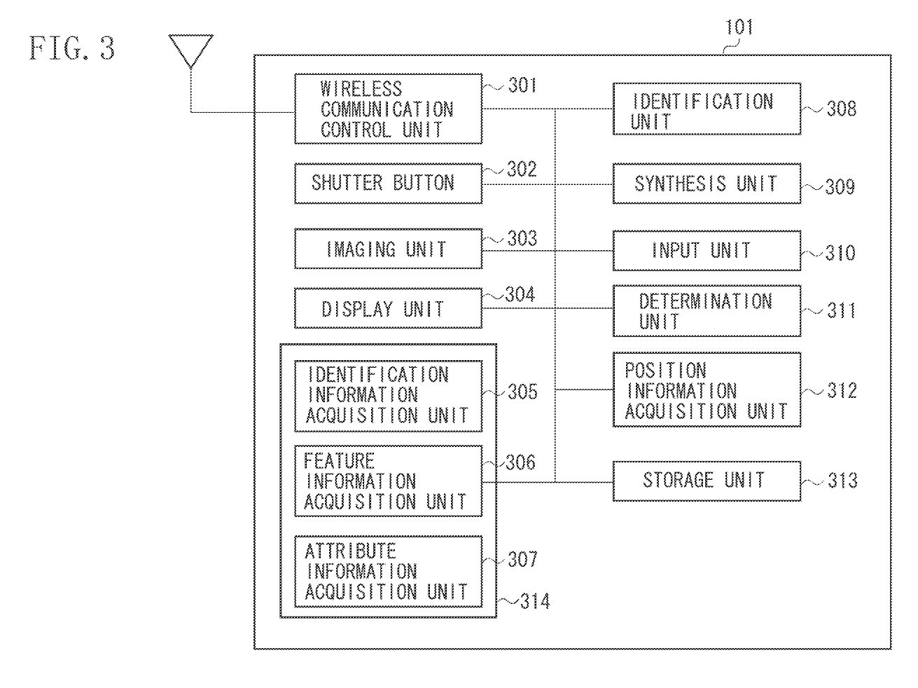

The configuration of the digital camera 101, i.e., the display control apparatus, will be described with reference to FIG. 3.

The digital camera 101 includes a central processing unit (CPU). The CPU executes a control program to perform information operations, processing, and hardware control, whereby the components to be described below are implemented.

A wireless communication control unit 301 controls an antenna and circuits to transmit and receive wireless signals to/from external apparatuses for communication. The wireless communication control unit 301 controls communication processing compliant to the Institute of Electrical and Electronics Engineers (IEEE) 802.11.

A shutter button 302 is a button for starting to capture an image. Detecting the depression of the shutter button 302 by the user, an imaging unit 303 controls a start of image capturing processing.

The imaging unit 303 includes a lens, an image sensor, and an analog-to-digital (A/D) conversion unit. The imaging unit 303 captures an image of object light acquired through the lens, and generates image data based on the captured object light. A display unit 304 performs display control to display the captured image and various types of information on a display.

An acquisition unit 314 includes an identification information acquisition unit 305, a feature information acquisition unit 306, and an attribute information acquisition unit 307. The acquisition unit 314 controls the wireless communication control unit 301 to acquire and store various types of information.

The identification information acquisition unit 305 acquires identification information 201 about a terminal apparatus that lies within a communication coverage. The identification information 201 is received from the wireless communication control unit 301.

The feature information acquisition unit 306 makes an inquiry to the server 111 based on the identification information 201 acquired by the identification information acquisition unit 305. The feature information acquisition unit 306 thereby acquires feature information 204 associated with the identification information 201 from the server 111.

The attribute information acquisition unit 307 makes an inquiry to the server 111 based on the identification information 201 acquired by the identification information acquisition unit 305. The attribute information acquisition unit 307 thereby acquires the attribute information associated with the identification information 201 from the server 111.

An identification unit 308 is a piece of hardware or a program for identifying a predetermined object from the image data captured by the imaging unit 303 based on the feature information acquired by the acquisition unit 314. In the present exemplary embodiment, the identification unit 308 performs known face recognition processing to detect an object corresponding to the feature information acquired by the acquisition unit 314.

A synthesis unit 309 associates the object identified by the identification unit 308 with the attribute information corresponding to the object, and synthesizes the object and the attribute information with the image data in a position near the object or in an arbitrary position on the image data. The synthesis unit 309 thereby generates synthesized image data.

An input unit 310 includes an input device for the user to input a query from, such as a touch panel and operation buttons. The input unit 310 controls the input device and retains input information. As employed herein, a query refers to information for determining whether apiece of the attribute information is user-desired information.

A determination unit 311 compares the attribute information corresponding to the identifier of the terminal apparatus lying within the communication coverage of the digital camera 101 with the query acquired by the input unit 310. The determination unit 311 thereby determines relevance of the attribute information to the query. In other words, the determination unit 311 determines whether the attribute information acquired by the acquisition unit 314 is user-desired information.

A position information acquisition unit 312 includes a GPS unit and an electronic compass which acquire position information about the digital camera 101 such as latitude, longitude, direction, and altitude. A storage unit 313 includes a read-only memory (ROM) and a random access memory (RAM). The storage unit 313 stores programs and various types of data for controlling the digital camera 101.

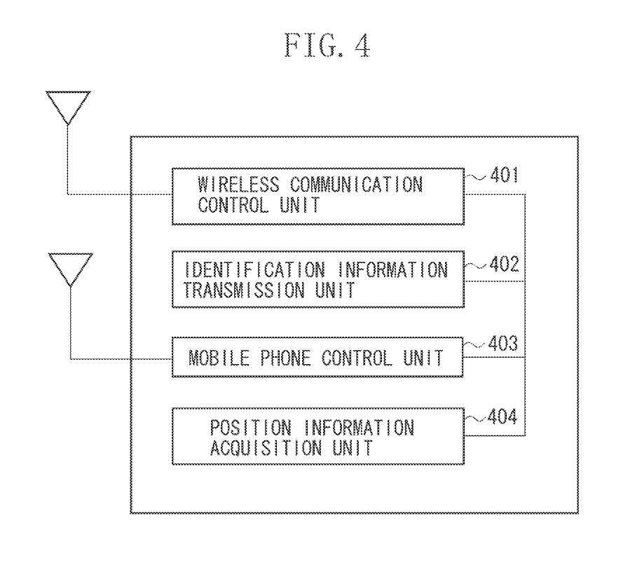

Now, the configuration of the mobile phones 103, 105, 107, and 109 will be described with reference to FIG. 4.

The mobile phones 103, 105, 107, and 109 are mobile phones having a wireless local area network (LAN) function compliant to IEEE 802.11. The owners of the mobile phones 103, 105, 107, and 109 are the persons 102, 104, 106, and 108, respectively.

The mobile phones 103, 105, 107, and 109 retain an identifier that allows unique identification of the respective mobile phones 103, 105, 107, and 109. The mobile phones 103, 105, 107, and 109 each include a CPU. Each CPU executes a control program to perform information operations, processing, and hardware control, whereby the components to be described below are implemented.

A wireless communication control unit 401 illustrated in FIG. 4 controls an antenna and circuits for transmitting and receiving wireless signals to/from other wireless apparatuses over the wireless LAN.

An identification information transmission unit 402 controls the wireless communication control unit 401 to notify retained identification information (identifier) on a regular basis or in response to a request from another apparatus. The identification information transmission unit 402 transmits the identification information (identifier) as an information element of an IEEE 802.11 beacon frame.

A mobile phone control unit 403 controls an antenna and circuit for making operations as a mobile phone. The mobile phone control unit 403 thereby connects to a mobile phone communication network and performs communications with other apparatuses.

A position information acquisition unit 404 includes a GPS unit and an electronic compass which acquire position information for identifying the position of the terminal apparatus, such as latitude, longitude, direction, altitude, etc.

The operation of the system having the foregoing configuration in the present exemplary embodiment will be described. Here, an operation example of the system will be described in conjunction with FIG. 1 described above.

In FIG. 1, suppose that the persons 102 and 104 are in the image capturing range of the digital camera 101, and the persons 106 and 108 are not in the image capturing range of the digital camera 101.

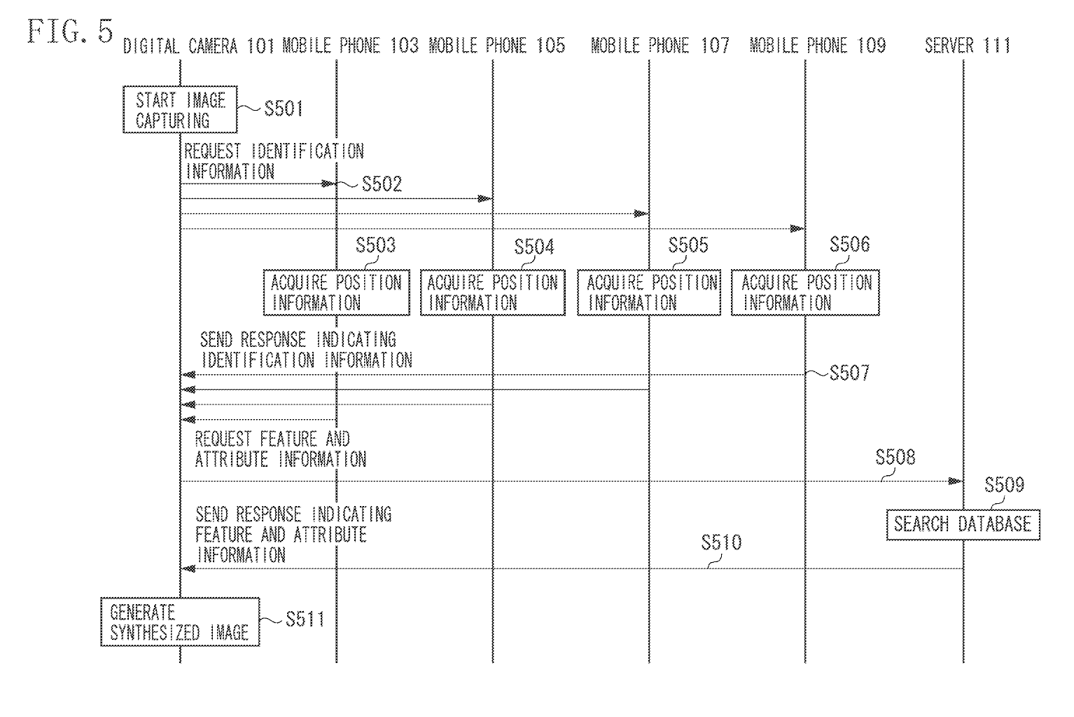

FIG. 5 illustrates a sequence when the digital camera 101 performs the image capturing processing and displays, on the captured image, the attribute information corresponding to the terminal apparatuses that lie within a communication coverage.

In step S501, the digital camera 101 initially detects an operation on the shutter button 302 and starts image capturing processing.

In step S502, the acquisition unit 314 of the digital camera 101 requests the identification information 201 from the terminal apparatuses that lie in the communication coverage. Specifically, the acquisition unit 314 controls the wireless communication control unit 301 to broadcast an IEEE 802.11 probe request frame.

In steps S503, S504, S505, and S506, the mobile phones 103, 105, 107, and 109, receiving the probe request frame, acquire their own position information by using their respective position information acquisition units 404.

In step S507, the mobile phones 103, 105, 107, and 109 send probe response frames indicating the identification information 201 and the position information corresponding to the respective terminal apparatuses 103, 105, 107, and 109.

The digital camera 101 receives the probe response frames. The acquisition unit 314 acquires the identification information 201 and the position information about the mobile phones 103, 105, 107, and 109 from the respective probe response frames.

In step S508, the digital camera 101, acquiring the identification information 201, makes an inquiry to the server 111 to acquire the feature information 204 and the attribute information corresponding to the identification information 201. Specifically, the digital camera 101 requests pieces of the feature information 204 and the attribute information corresponding to the pieces of the identification information 201 from the server 111 based on the pieces of the identification information 201 acquired from the respective mobile phones 103, 105, 107, and 109.

In step S509, the server 111 receives the inquiry from the digital camera 101, and searches the database for the attribute information and the feature information 204 associated with the identification information 201 based on the identification information 201 included in the inquiry.

In step S510, the server 111 sends the attribute information (names 202 and comments 203) and the feature information 204 associated with the identification information 201 about the respective mobile phones 103, 105, 107, and 109 to the digital camera 101.

In step S511, the digital camera 101 synthesizes the captured image and the attribute information based on the attribute information and the feature information 204 received from the server 111. The digital camera 101 displays the synthesized image on the display unit 304.

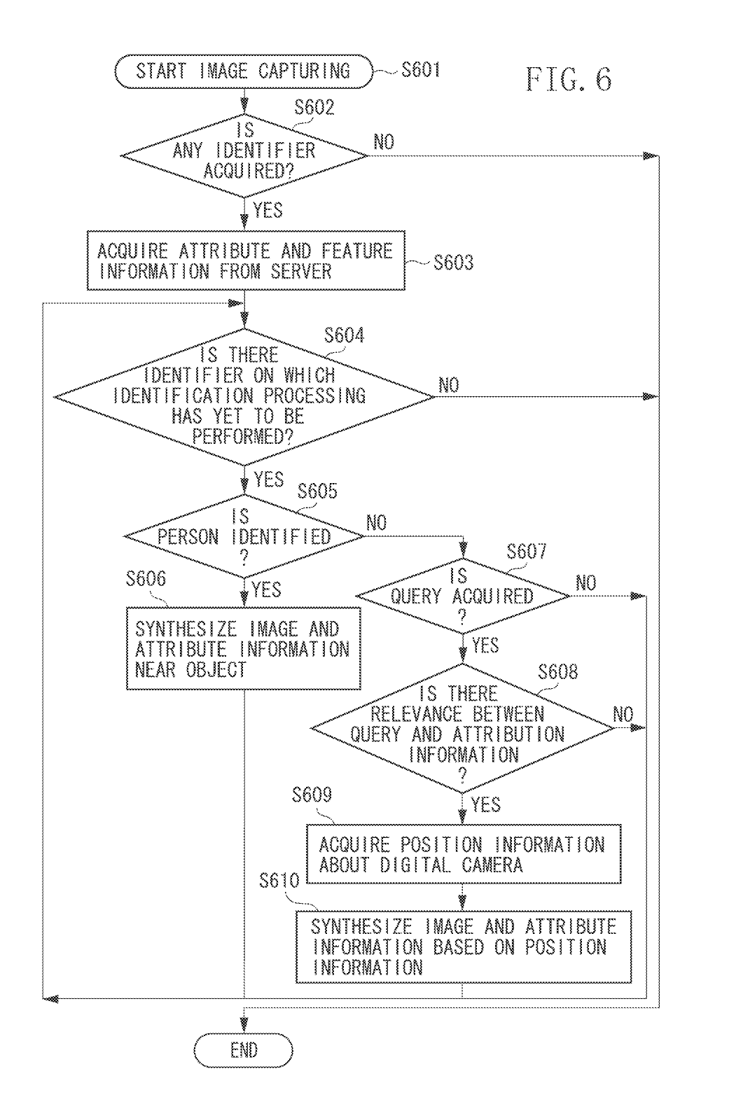

Processing by which the digital camera 101 captures an image will be described with reference to the flowchart in FIG. 6. The persons 102 and 104 illustrated in FIG. 1 are described to be in the image capturing range, and the persons 106 and 108 are described not to be in the image capturing range.

The following description deals with a case where no query is input to the digital camera 101, i.e., only attribute information corresponding to objects detected on a captured image is displayed.

In step S601, the user initially makes an operation on the shutter button 302 of the digital camera 101 to start image capturing processing. As employed herein, the operation on the shutter button 302 may include an instruction for automatic focus control that is started by a predetermined operation such as half-pressing on the shutter button 302.

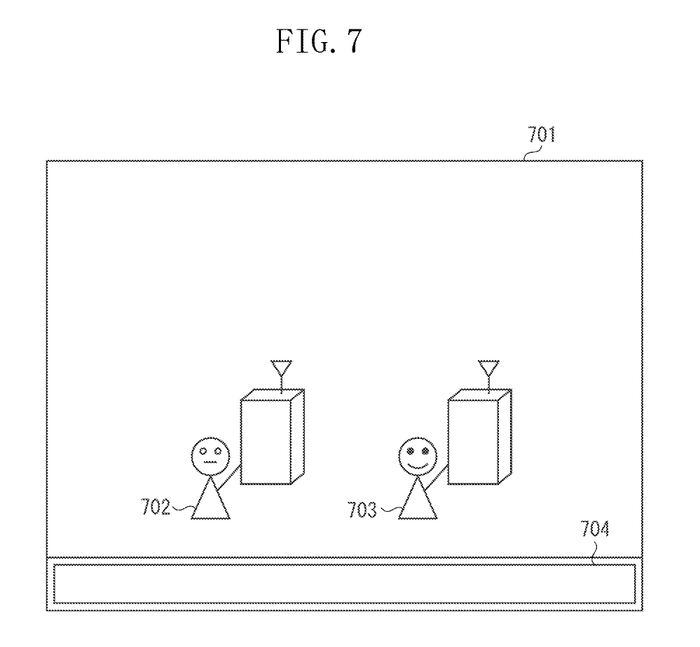

FIG. 7 illustrates a screen that is displayed here on the display unit 304. The image 701 is generated by the imaging unit 303. An object 702 and an object 703 are displayed in the image 701. The objects 702 and 703 correspond to captured images of the persons 102 and 104, respectively.

A user input display section 704 displays a user-input query acquired by the input unit 310. Since no query is input, nothing is displayed here.

In step S602, after the start of the image capturing processing, the digital camera 101 acquires identification information 201 (identifiers) and position information about terminal apparatuses lying within the communication coverage from the terminal apparatuses. Specifically, the digital camera 101 performs the processing illustrated in steps S502 to S507, which have been described in FIG. 5. The digital camera 101 thereby acquires the identification information 201 (identifiers) and position information about the mobile phones 103, 105, 107, and 109 from the respective apparatuses.

In step S603, having acquired the identification information 201 about the terminal apparatuses lying in the communication coverage, the digital camera 101 issues a request including the acquired identification information 201. The digital camera 101 thereby acquires attribute information and feature information 204 associated with the identification information 201 from the server 111. Specifically, the digital camera 101 performs the processing illustrated in steps S508 to S510 to acquire the attribute information and feature information 204 associated with the identification information 201.

The acquired information includes the names 202, comments 203, and feature information 204 associated with the pieces of identification information 201 like illustrated in FIG. 2. Next, the digital camera 101 performs the processing of step S604 and subsequent steps of the flowchart on all the acquired identifiers in order. Such processing corresponds to the processing for generating a synthesized image in step S511 in FIG. 5.

In step S605, the identification unit 308 of the digital camera 101 attempts to detect an object corresponding to a piece of acquired feature information 204 from the captured image by using the feature information 204. Identification processing on a piece of acquired identification information 201 “00:00:85:00:00:01”, which corresponds to the mobile phone 103, will be described below.

The identification unit 308 performs processing for detecting the person 102 from the image 701 illustrated in FIG. 7 by using the feature information 204 (Taro.jpg) corresponding to the identification information 201 “00:00:85:00:00:01”. As a result of step S605, the identification unit 308 detects an object corresponding to the identification information 201 from the image 701, whereby the subject 702 is identified to be the person 102.

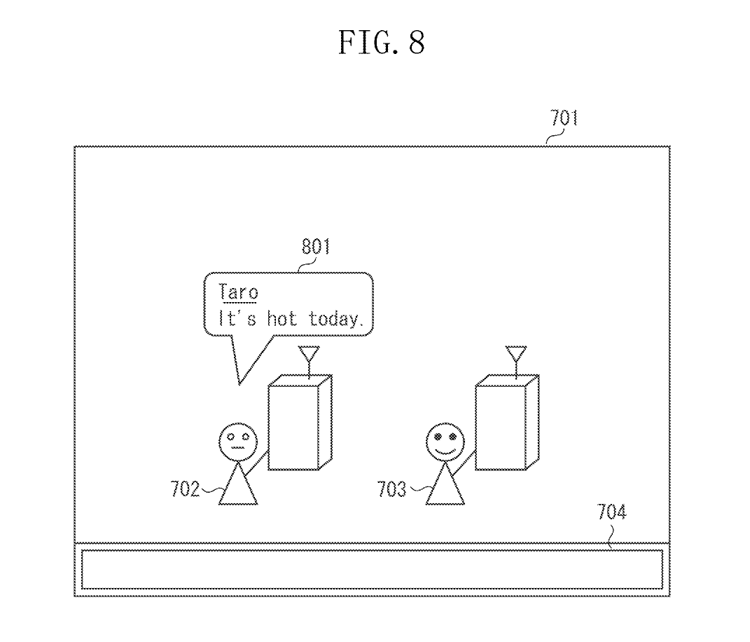

In step S606, the synthesis unit 309 associates the attribute information (name 202 and comment 203) with the detected object 702, and synthesizes the attribute information with the image 701 so that the attribute information appears near the object 702. The display unit 304 displays the synthesized image. FIG. 8 illustrates an example of the synthesis result.

A balloon 801 shows the attribute information associated with and synthesized near the object 702. The user of the digital camera 101 can view the balloon 801 to acquire information about the person 102. The user can easily recognize that the information is associated with the person 102.

Now, identification processing on identification information 201 “00:00:85:00:00:02”, which corresponds to the mobile phone 105, will be described. Again, in step S605, the identification unit 308 detects an object corresponding to the person 104 from the image 701 and identifies the person 104.

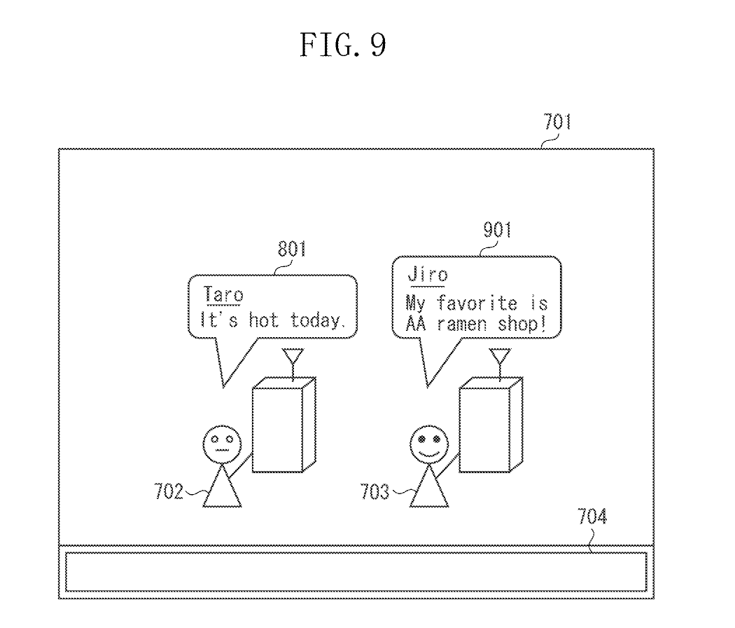

If the object 703 is successfully identified to be the person 104 (YES in step S605), then in step S606, the synthesis unit 309 synthesizes the image 701 and the acquired attribute information associated with the person 104 so that the attribute information appears near the object 703. The display unit 304 displays the synthesized image. FIG. 9 illustrates an example of the synthesis result.

A balloon 901 shows the attribute information associated with and synthesized near the object 703.

Identification processing on identification information 201 “00:00:85:00:00:03”, which corresponds to the mobile phone 107, and identification information 201 “00:00:85:00:00:04”, which corresponds to the mobile phone 109, will be described below. While the pieces of identification information are independently processed, the processing is similar and will thus be described together.

In step S605, the identification unit 308 performs processing for detecting the person 106 and the person 108 from the image 701 by using the feature information 204 (Saburo.jpg and Shiro.jpg) associated with the identification information 201.

Since the image 701 does not include the person 106 or the person 108, neither the person 106 nor the person 108 is detected (NO in step S605). In step S607, the digital camera 101 attempts to acquire a user-input query by using the input unit 310. In other words, the digital camera 101 determines whether the user wishes to display user-desired information included in the attribute information about the objects that are not included in the captured image.

Since there is no query input by the user (NO in step S607), the digital camera 101 ends the processing on the identification information 201 “00:00:85:00:00:03” and the identification information 201 “00:00:85:00:00:04”. The display unit 304 therefore does not display the attribute information associated with the identification information 201 “00:00:85:00:00:03” or the identification information 201 “00:00:85:00:00:04”.

As a result of such processing on all the pieces of acquired identification information 201, the user can obtain the display screen illustrated in FIG. 9. The user can thus obtain information about the captured objects. As described above, the user can acquire only additional information about the objects lying in the imaging range by inputting no query.

Next, a case where the user inputs a query will be described. In other words, a description will be given of the case where the user wishes to display user-desired information included in attribute information about objects that are not included in the captured image.

Inputting a query can be useful if the user wants not information about a certain object but a certain piece of information. If the user wishes to display such desired information, the user inputs a query for determining whether a piece of attribute information is user-desired information by using the input unit 310 before the start of the foregoing image capturing processing.

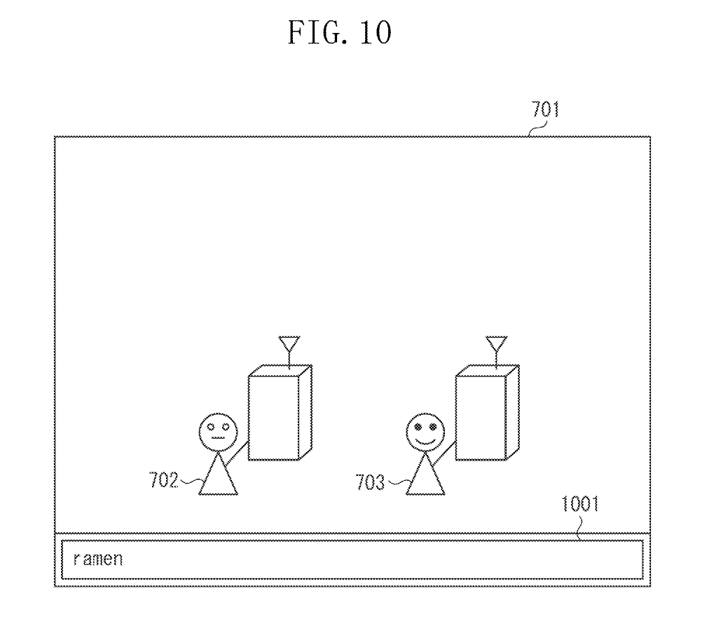

The input query is displayed on the display unit 304. FIG. 10 illustrates a screen where the user inputs “ramen” as a query. The user input display section 1001 displays the character string “ramen” input by the user.

The image capturing processing of the digital camera 101 when the user inputs a query will be described with reference to FIG. 6. When a query is input, the processing of step S607 and subsequent steps differs from the foregoing processing without a query. More specifically, the processing on the identification information 201 “00:00:85:00:00:03” of the mobile phone 107 (person 106) and the identification information 201 “00:00:85:00:00:04” of the mobile phone 109 (person 108) is different from the foregoing processing without a query. The processing of step S607 and subsequent steps will be described in detail below with respect to the identification information 201 “00:00:85:00:00:03” and the identification information 201 “00:00:85:00:00:04” separately.

Firstly, the digital camera 101 initially performs the foregoing processing of steps S601 to S605 on the identification information 201 “00:00:85:00:00:03” of the mobile phone 107.

In step S605, the identification unit 308 cannot identify the person 106 corresponding to the identification information 201 “00:00:85:00:00:03” in the image 701 (NO in step S605), and the processing proceeds to step S607. In step S607, the digital camera 101 attempts to acquire a query, and successfully acquires a query “ramen”.

If the query is successfully acquired (YES in step S607), then in step S608, the determination unit 311 compares the acquired query with the attribute information associated with the identification information 201 “00:00:85:00:00:03” to determine whether there is a relevance.

The determination unit 311 determines whether the character string of the acquired query, “ramen”, is relevant to the attribute information associated with the identification information 201 “00:00:85:00:00:03”. In other words, the determination unit 311 determines whether the attribute information is user-desired information.

Since the attribution information or comment 203 “BB ramen shop is good”, includes the character string of the query “ramen”, the determination unit 311 determines that there is a relevance.

The processing of step S608 may be configured to determine relevance between a query and attribution information by using known natural language processing. More specifically, the determination unit 311 may determine not only whether the attribute information includes the same character string as a query keyword, but also whether the attribute information is relevant to keywords and synonyms that are relevant to the query.

In step S608, if the determination unit 311 determines that there is a relevance (YES in step S608), then in step S609, the position information acquisition unit 312 acquires position information about the digital camera 101.

In step S610, the synthesis unit 309 synthesizes the attribution information (name 202 and comment 203) associated with the identification information 201 and the image 701 based on the acquired position information about the digital camera 101 and the position information about the mobile phone 107 which has been acquired with the identification information 201. The display unit 304 displays the synthesized image.

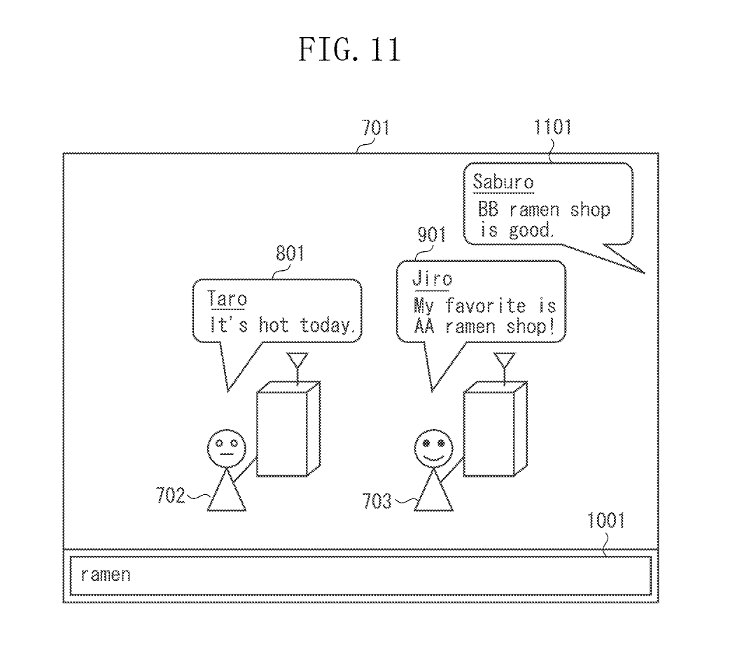

FIG. 11 illustrates a display example of the image synthesized in step S610. A balloon 1101 shows the synthesized attribute information about the mobile phone 107 (identification information 201 “00:00:85:00:00:03”). The synthesis unit 309 determines the positional relationship between the digital camera 101 and the mobile phone 107 to find that the person 106 who owns the mobile phone 107 is on the right of the digital camera 101. Based on the positional relationship, the balloon 1101 is displayed in the right area of the image 701.

The display unit 304 also displays the balloon 1101 as if the balloon 1101 originates from outside the image 701. The display unit 304 thereby provides a display that allows an at-a-glance recognition that the object corresponding to the balloon 1101 is not included in the captured image.

Next, the processing on the identification information 201 “00:00:85:00:00:04” corresponding to the mobile phone 109 will be described. Like the processing on the identification information of the mobile phone 107, the processing proceeds up to step S607. In step S607, the digital camera 101 acquires a query “ramen”.

In step S608, the determination unit 311 of the digital camera 101 compares the acquired query with the attribute information associated with the identification information 201 “00:00:85:00:00:04” to determine whether there is a relevance.

Since the character strings of the attribute information, i.e., the name 202 “Shiro” and the comment 203 “I'm looking for a good noodle shop”, do not include the character string of the query “ramen”, the determination unit 311 determines there is no relevance. In other words, the determination unit 311 determines that the attribute information is not user-desired information.

If the determination unit 311 determines that there is no relevance (the attribute information is not user-desired information) (NO in step S608), the display unit 304 will not display the attribute information associated with the identification information 201 “00:00:85:00:00:04”.

As described above, according to the present exemplary embodiment, attribute information corresponding to a predetermined object that does not lie in the imaging range but in the communication coverage is displayed when the attribute information is user-desired information even if the predetermined object cannot be identified in the captured image.

The user can thus acquire desired information without any trouble of framing the predetermined object in the imaging range. According to conventional techniques, even if an object with desired attribute information is framed in the imaging range, the attribute information cannot be displayed unless the identification processing of step S605 succeeds.

On the other hand, in the present exemplary embodiment, user-desired information is displayed even if the identification processing of step S605 is not successful. This can increase the chances for the user to acquire the information. In addition, the attribute information is displayed to show approximate positions of the display control apparatus and the object associated with the attribute information. This provides an effect that the user can easily find the object.

Displaying only the user-desired information among the attribute information associated with objects lying outside the imaging range provides high user-friendliness. For example, in FIG. 11, the attribute information about the person 106 is displayed in the right area of the image 701. The user of the digital camera 101 can thus turn the digital camera 101 to the right of the screen and capture an image again to easily identify the person 106 who has the attribute information.

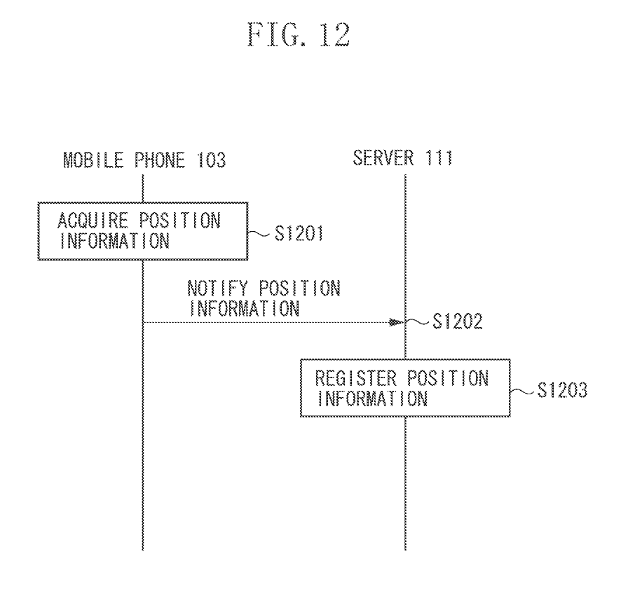

A second exemplary embodiment will now be described. A difference from the first exemplary embodiment lies in the method by which the digital camera 101 acquires the position information about the mobile phones 103, 105, 107, and 109. The system configuration, the digital camera 101, and the mobile phones 103, 105, 107, and 109 are the same as in the first exemplary embodiment. Description of the same points as in the first exemplary embodiment will be omitted. Referring to FIGS. 12, 13, and 14, differences of the present exemplary embodiment from the first exemplary embodiment will be described in detail.

FIG. 12 illustrates a sequence diagram when the mobile phone 103 transmits its own position information to the server 111. The mobile phones 105, 107, and 109 also notify their position information to the server 111 by a similar sequence.

In step S1201, the mobile phone 103 initially acquires its own position information by using the position information acquisition unit 404. In step S1202, the mobile phone 103 adds its own identifier to the acquired position information, and transmits the resultant to the server 111 through the mobile phone control unit 403. In step S1203, the server 111 receives the position information about the mobile phone 103 and registers the position information in the database.

The mobile phones 103, 105, 107, and 109 perform position information registration processing illustrated in FIG. 12 on a regular basis. Consequently, the latest position information can be registered in the server 111 on a regular basis even if the mobile phones 103, 105, 107, and 109 move in position.

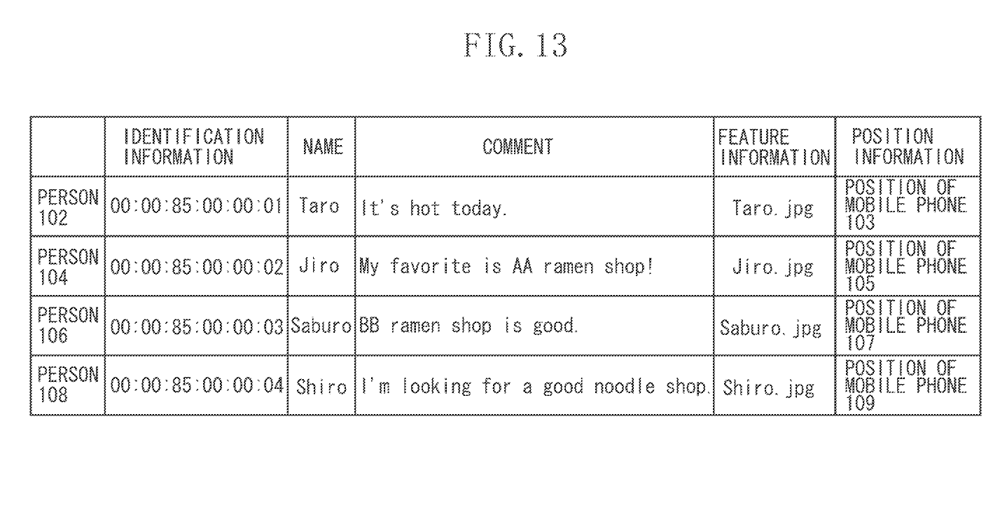

FIG. 13 illustrates an example of information stored in the database managed by the server 111 according to the present exemplary embodiment. In addition to the identification information 201, the name 202, the comment 203, and the feature information 204 illustrated in FIG. 2, the position information registered by the procedure illustrated in FIG. 12 is associated and included in the database. The position information is registered in the form of binary data or numerical information that expresses latitude, longitude, direction, and altitude.

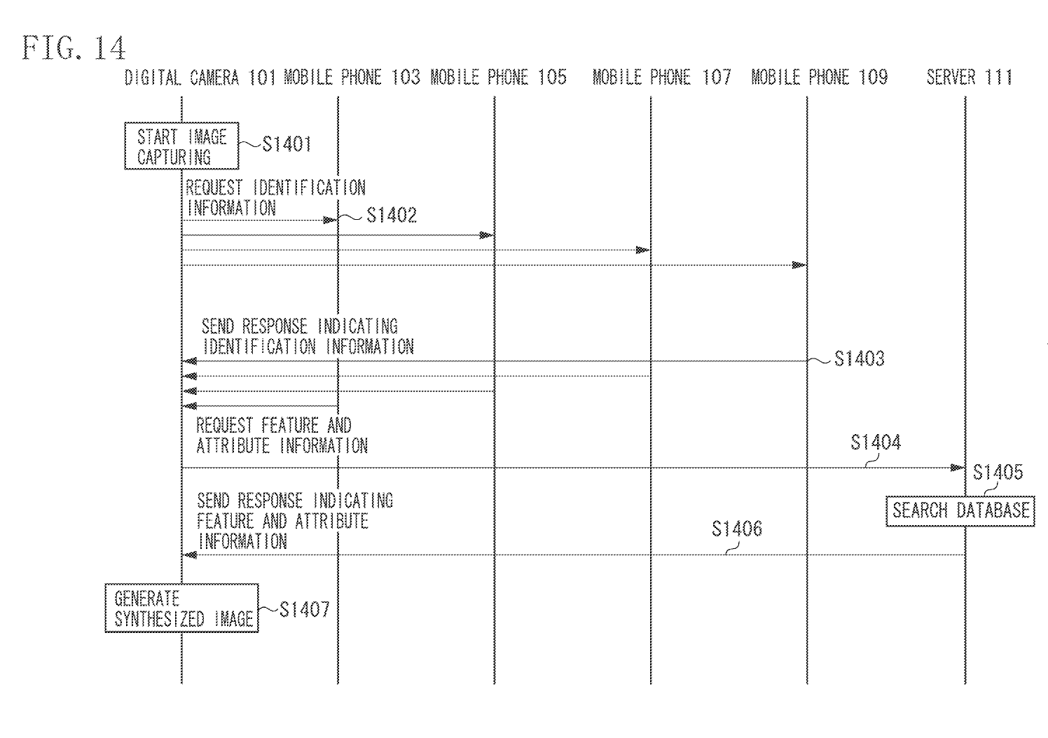

FIG. 14 is a sequence diagram among the mobile phones 103, 105, 107, and 109, and the server 111 when the digital camera 101 captures an image.

In step S1401, the user initially presses the shutter button 302 of the digital camera 101 to start image capturing. In step S1402, the acquisition unit 314 of the digital camera 101 requests identification information from the terminal apparatuses lying in the communication coverage. This processing is the same as in the first exemplary embodiment.

In step S1403, the mobile phones 103, 105, 107, and 109, receiving such identification information request, transmit their respective pieces of identification information to the digital camera 101. The acquired identification information includes the four pieces of identification information illustrated in FIG. 13.

In step S1404, the digital camera 101, receiving the identification information, inquires of the server 111 about attribute information and feature information associated with the identification information as in the first exemplary embodiment.

In step S1405, the server 111 searches the database for attribute information, feature information, and position information associated with the identification based on the received identification information. In step S1406, the server 111 completes the search and transmits the search result to the digital camera 101.

In step S1407, the digital camera 101 receives the search result and synthesizes a captured image and the search result into a synthesized image as in the first exemplary embodiment. The processing can be expressed by the processing of step S604 and subsequent steps as in the first exemplary embodiment. A description thereof will thus be omitted.

Since the only difference from the first exemplary embodiment lies in the method for acquiring position information, the same synthesized image result is obtained as in the first exemplary embodiment. More specifically, if the user of the digital camera 101 inputs no query, the resulting image is like FIG. 9. If the user inputs a query, the resulting image is like FIG. 11.

As described above, according to the present exemplary embodiment, attribute information corresponding to a predetermined object that does not lie in the imaging range but in the communication coverage is displayed when the attribute information is user-desired information even if the predetermined object cannot be identified in the captured image. The user can thus acquire desired information without any trouble of framing the predetermined object in the imaging range.

In addition, the attribute information is displayed to show approximate positions of the display control apparatus and the object relevant to the attribute information. This provides an effect that the user can easily find the object.

Displaying only the user-desired information among the attribute information related to objects lying outside the imaging range provides high user-friendliness. For example, in FIG. 11, the attribute information about the person 106 is displayed in the right area of the image 701. The user of the digital camera 101 can thus turn the digital camera 101 to the right of the screen and capture an image again to easily identify the person 106 who has the attribute information.

In another configuration, an exemplary embodiment of the claimed invention may identify persons and display attribute information by using a moving image, not a still image. Such a configuration may be implemented by processing the frames of the moving image as still images in succession.

Communications for transmitting and acquiring identification information are not limited to IEEE 802.11 wireless LAN communications, and may use Bluetooth, passive/active radio frequency identification (REID), etc. A plurality of wireless communication interfaces such as a wireless LAN and passive RFID may be used to simultaneously perform communications about identification information. Millimeter-wave and other directional wireless methods may be used to transmit and acquire identification information.

The position information acquisition unit 312 is not limited to the GPS-based acquisition of position information, and may identify approximate positions of objects based on the incident angles of radio waves by using a directional antenna such as an adaptive array antenna. In the first and second exemplary embodiments, the attribute information corresponding to the pieces of identification information is linked with, though not limited to, persons. Attribute information may be linked with buildings, such as a shop, or certain objects.

A query for the user to input is not limited to a character string. For example, the digital camera 101 may be configured so that a plurality of modes such as a restaurant mode and a sport mode can be selected on-screen. The user may select a certain mode from the plurality of modes as a query.

More specifically, queries and attribute information may be classified into predetermined types in advance so that the processing of step S608 can be performed by matching thereof. Attribute information about the user himself/herself may be used as a query. For example, suppose that the person 102 is the user of a display device to which an exemplary embodiment of the claimed invention is applicable. The attribute information associated with the person 102, such as “Taro” and “It's hot today”, may be used as a query.

In the foregoing exemplary embodiments, attribute information corresponding to an object that is identified in the captured image is displayed regardless of whether the attribute information is relevant to an input query. However, the attribute information corresponding to the object identified in the captured image may not be displayed if the attribute information is irrelevant to the input query.

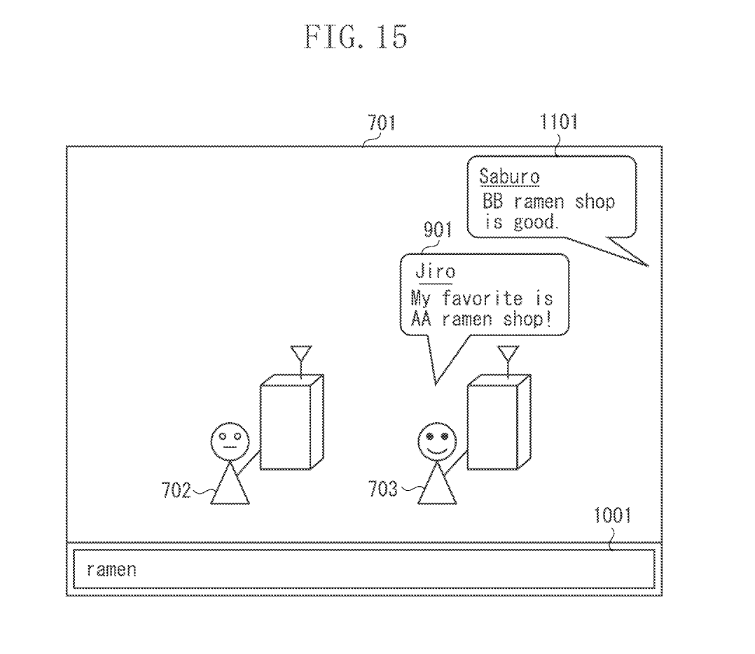

For example, suppose that “ramen” is input as a query as illustrated in FIG. 15. In such a case, the balloon 801 illustrated in FIG. 8 and so on corresponding to the object 702 that is irrelevant to “ramen” is not displayed. Such a configuration can display only information necessary for the user, so that the user can easily acquire desired information.

The present exemplary embodiment has dealt with the processing that uses the attribute information and the feature information corresponding to the identifiers directly acquired from other apparatuses by using wireless communications at the start of image capturing processing. However, the identifiers (or attribute information and/or feature information) of the other apparatuses may be acquired and stored in advance before image capturing, and may be used for subsequent processing. In such a case, the attribute information to be displayed in step S610 may be filtered based on the position information about the other apparatuses, the acquisition time of the identifiers of the other apparatuses, the position information about the other apparatuses at the acquisition time, and the time when an instruction to display the attribute information is given.

This can avoid displaying the attribute information about other apparatuses that are considered to be physically located far from the digital camera 101 even if the attribute information is relevant to a query.

For example, suppose that there is a predetermined time difference between the time when the identifier of another apparatus is acquired and the time when an instruction to display the attribute information is given. In such a case, the attribute information corresponding to the identifier of the other apparatus is not displayed even if the attribute information is relevant to a query. Suppose also that the own apparatus is positioned more than a predetermined distance away from the position information when the identifier of another apparatus is acquired. In such a case, the attribute information corresponding to the identifier of the other apparatus is not displayed even if the attribute information is relevant to a query. Such a configuration can display user-desired information corresponding to the identifiers of other apparatuses that are considered to be within a certain distance from the own apparatus.

An exemplary embodiment of the claimed invention may be implemented by performing the following processing. The processing includes supplying software (program) for implementing the functions of the foregoing exemplary embodiments to a system or an information processing apparatus over a network or through various types of storage media serving as a memory device (e.g. a non-transitory storage medium), and reading and executing the program by a computer (e.g., a CPU, a microprocessing unit (MPU), and/or the like) of the system or the information processing apparatus.

While the claimed invention has been described with reference to exemplary embodiments, it is to be understood that the claimed invention is not limited to the disclosed exemplary embodiments. The scope of the following claims is to be accorded the broadest interpretation so as to encompass all modifications, equivalent structures, and functions.

This application claims priority from Japanese Patent Application No. 2011-192850 filed Sep. 5, 2011, which is hereby incorporated by reference herein in its entirety.

What is claimed is:

1. A display control apparatus comprising:
an identifier acquisition unit configured to acquire an identifier of another apparatus;
an information acquisition unit configured to acquire information associated with the acquired identifier;
a detection unit configured to detect an object corresponding to the acquired identifier from a captured image;
a first display control unit configured to cause a display unit to display information corresponding to the identifier corresponding to the object detected by the detection unit; and
a second display control unit configured to cause the display unit to display information relevant to a query input by a user, included in the information corresponding to the identifier corresponding to an object not detected by the detection unit.

2. The display control apparatus according to claim 1, wherein the first display control unit is configured to cause the display unit to display the object detected by the detection unit and the information associated with the identifier corresponding to the object in association with each other.

3. The display control apparatus according to claim 1, further comprising a position acquisition unit configured to acquire a position of the another apparatus and a position of the display control apparatus,
wherein the second display control unit is configured to control a position used to display the information acquired by the information acquisition unit on the display unit based on the positions acquired by the position acquisition unit.

4. The display control apparatus according to claim 3, wherein the second display control unit is configured to control the position used to display the information acquired by the information acquisition unit on the display unit in such a manner that the position of the another apparatus having the identifier corresponding to the information is indicated, based on the positions acquired by the position acquisition unit.

5. The display control apparatus according to claim 1, wherein the second display control unit is configured to cause the display unit to display the information acquired by the information acquisition unit to indicate that the information corresponds to an object not detected by the detection unit.

6. The display control apparatus according to claim 1, further comprising a determination unit configured to determine whether the information acquired by the information acquisition unit is relevant to the query,
wherein the second display control unit is configured to display the information that is determined to be relevant by the determination unit.

7. The display control apparatus according to claim 1, wherein the second display control unit is configured to display the information acquired by the information acquisition unit as information relevant to the query if the information acquired by the information acquisition unit includes a keyword that is input as the query.

8. The display control apparatus according to claim 1, wherein a display mode of the first display control unit is different from a display mode of the second display control unit.

9. The display control apparatus according to claim 1, wherein the second display control unit is configured not to perform control if the query is not input.

10. The display control apparatus according to claim 1, wherein the first display control unit is configured not to perform control if the query is input.

11. The display control apparatus according to claim 1, wherein the identifier acquisition unit is configured to acquire the identifier of the another apparatus by performing direct communication with the another apparatus.

12. The display control apparatus according to claim 1, wherein the captured image is an image captured by the display control apparatus.

13. A method for controlling a display control apparatus, comprising:
acquiring an identifier of another apparatus;
acquiring information associated with the acquired identifier;
detecting an object corresponding to the acquired identifier from a captured image;
causing a display unit to display information corresponding to the identifier corresponding to the detected object; and
causing the display unit to display information relevant to a query input by a user, included in the information corresponding to the identifier corresponding to an undetected object.

14. A display control apparatus comprising:
an identifier acquisition unit configured to acquire an identifier of another apparatus;
an information acquisition unit configured to acquire information associated with the acquired identifier;
a detection unit configured to detect an object corresponding to the acquired identifier from a captured image; and
a display control unit configured to cause a display unit to display information corresponding to the identifier corresponding to the object detected by the detection unit, and information that corresponds to the acquired identifier and is relevant to a query input by a user.

15. A method for controlling a display control apparatus, comprising:
acquiring an identifier of another apparatus;
acquiring information associated with the acquired identifier;
detecting an object corresponding to the acquired identifier from a captured image; and
causing a display unit to display information corresponding to the identifier corresponding to the detected object, and information that corresponds to the acquired identifier and is relevant to a query input by a user.

16. A non-transitory storage medium storing a program for causing a computer to perform the method according to claim 13.

17. A non-transitory storage medium storing a program for causing a computer to perform the method according to claim 15.
